(19) United States
(12) Patent Application Publication
(10) Pub. No.: US 2017/0028907 A1
(43) Pub. Date: Feb. 2, 2017

(54) Door opening warning device for car

(71) Applicant: Yin-Wen Chen, Hsinchu (TW)

(72) Inventor: Yin-Wen Chen, Hsinchu (TW)

(21) Appl. No.: 14/811,846

(22) Filed: Jul. 29, 2015

(51) Int. Cl. B60Q 1/46

(52) U.S. Cl. CPC B60Q 1/46

(57) ABSTRACT

A door opening warning device for car, comprises: a controller electrically connected with a power unit; at least a sensor electrically connected with the said controller, mounted around an inside handle of car door; and an alert device electrically connected with the said controller; wherein the sensor signals to start the alert device, as the sensor is started, whereby it is alerted before car door is open.

### FIELD OF THE INVENTION

The present invention relates to a door opening warning device for car, particularly to a door opening warning device for car wherein a sensor is mounted on an inside handle of car door or around, whereby it is alerted, before a car door is open.

### BACKGROUND OF THE INVENTION

By street parking the driver has to open the car door very carefully for avoiding crash by car driver from rear. Normally driver of car from rear has no idea how long a car of street parking stays and loses his alertness. If a car door of street parking car is open suddenly, accident can happen because of car driver from rear, Hereby follows examples.

As a vehicle forwards in 50 kilometers per hour, about 13 meters per second, in this speed the driver of car from rear cannot judge if the a street parking car will open the door. Normally people think that the street parking car has parked for a long time and stays beyond. Therefore, crash between a car door of a street parking car and car driver from rear is still not totally avoided.

Besides, car door can easily be opened accidentally, e.g children playing a car handle by waiting for driver. It is very dangerous, not only the car driver from rear is prevented, but the children could also fall off the car. Therefore, car todays is equipped with child safety locks. However, the mentioned safety measures make uncomfortable, even if there are no children in car. As result the user gives up the function of the safety locks, nevertheless accidence can happen.

### SUMMARY OF THE INVENTION

The main object of the present invention is to provide a door opening warning device for car, wherein for car driver from rear a potential crash is alerted before a door of a street parking car is open.

For achieving above object the present invention comprises: a controller 1, electrically connected with a power unit 101; at least a sensor 2, mounted around an inside handle of car door, electrically connected with the said controller 1; and a alert device 3, electrically connected with the said controller 1; wherein the sensor 2 signals to start the alert device 3, as the sensor 2 is started.

Preferably, the sensor 2 is an infrared sensor or an electrostatic sensor or another sensing mode mounted around an inside handle of car door, wherein it signals the controller to start the alert device before car door is open. Thereby warning effect is achieved.

Preferably, the sensor 2 is mounted around an inside handle of car door 102, whereby the inside handle of car door 102 is covered by sensing rang of the sensor.

Preferably, the inside car door handle 102 is mounted within a handle recess 103; wherein the said sensor 2 is embedded within the car door, whereby inside of the handle recess 103 is covered by the sensing range. Thereby accidental starting is reduced.

Preferably, the controller 1 is electrically connected with a switch device of car 104; wherein the controller 1 signals to start the alert device 3, as the car is going to flameout. Thereby the warning function for car driver from rear is achieved.

Preferably, the controller 1 has a timing means; wherein the timing means makes the alert device 3 to start for a destined time. Thereby energy is saved.

Preferably, the controller 1 has a touching-on means, wherein the touching-on means causes signals transmitted from the sensor 2 to start the alert device 3 continuously, until the sensor 2 stops in a destined time.

Preferably, the alert device 3 has at least a first lighting device 31; wherein the first lighting device 31 is LED light or any light. Thereby warning effect is achieved.

Preferably, the controller 2 has a flash control means; wherein the flash control means causes the first lighting device 31 of the alert device 3 to flash on. Thereby warning effect is improved.

Preferably, the first lighting device 31 is set on an evident position on a car door outside, e.g. on the handle or around. Thereby pedestrians and cars driver from rear are easily warned.

Preferably, the first lighting device 31 is set on car door outside, wherein a sensor is mounted. Thereby pedestrians and car driver from rear are easily alerted.

Preferably, the controller 1 is electrically connected with plural sensors 2; wherein the said several sensors 2 are set on inside handles of car doors or around respectively; wherein the alert device 3 has plural first lighting devices 31; the plural first lighting devices 31 are set on outside car doors respectively; wherein amount of the first lighting devices depends on the amount of the doors of the car; wherein sensors on the doors of the same car can only start the first lighting device, whose door is opened. Thereby warning light is actually emitted.

Preferably, the alert device 3 has at least a second lighting device 32; wherein the second lighting device 32 is automotive lighting of the car or warning light set on the position of the automotive lighting of the car.

Preferably, the controller 1 is electrically connected with plural sensors 2; wherein the plural sensors 2 are mounted on the inside handles car doors or around respectively; wherein the sensors on the same side of the car start the corresponding second lighting devices on the same side. Thereby warning light is actually emitted.

Preferably, the alert device 3 has at least a sound device 33, wherein the sound device 33 is set upon the controller 1 or front and rear inside the car. Thereby the driver can identify which door is alarming.

Preferably, the sensor 2 is electronically connected with a monitor 4; wherein the monitor 4 is set on a dashboard of the car; wherein the said monitor 4 shows an open-closed status of respective car doors detected from the sensors 2 mounted on the car doors. Thereby driver can see the open-closed status of respective doors.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows the connection of the devices of the present invention.

FIG. 2 shows a sensor of the present invention mounted upon the inside handle of a car door.

FIG. 3 shows a sensor of the present invention embedded within a car door.

FIG. 4 shows a further connection with a switch device of the present invention.

FIG. 5 shows the devices of the present invention set on a car.

FIG. 6 shows a further connection with a monitor of the present invention.

### DESCRIPTION OF THE PREFERRED EMBODIMENTS

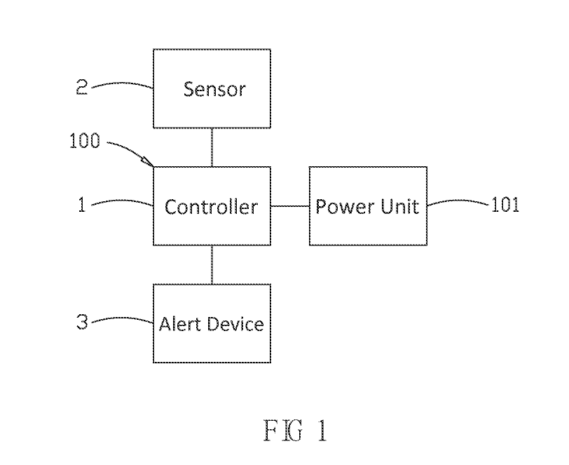

As shown in FIG. 1, a door opening warning device for car 100 comprises: a controller 1 electrically connected with a power unit 101; at least a sensor 2 electrically connected with the controller 1, mounted around an inside handle of car door; and an alert device 3 electrically connected with the controller 1; wherein the sensor 2 signals to start the alert device 3, as the sensor is started to work. Thereby it is alerted before car door is open.

The controller 1 electrically connected with a power unit 101 is a conventional control circuit, which is used to start the alert device 3, once signals from the sensor 2 are received, whereby pedestrian and car driver from rear are alerted; wherein the controller is set in the car; wherein the controller is combined with a control system of the car. Battery of the car directly or external battery is used for the power unit 101.

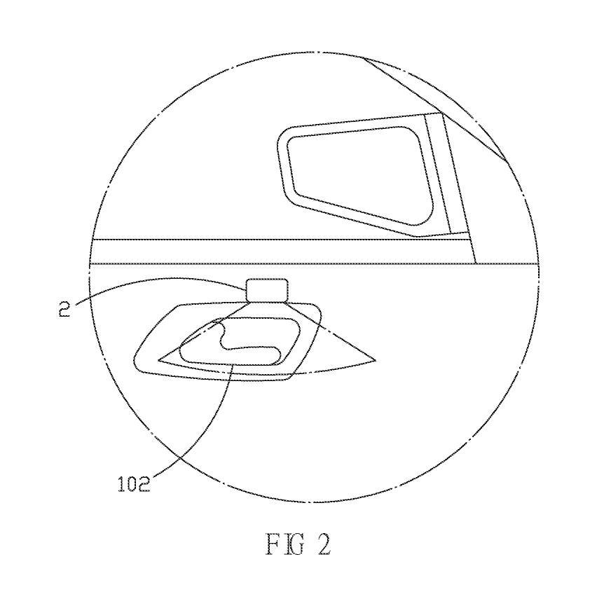

As shown in FIG. 2, the sensor 2 electrically connected with the controller, is mounted around an inside handle of car door; wherein it is an infrared sensor or an electrostatical sensor, wherein the sensor 2 signals the controller to start the alert device, before someone touches an inside handle of car door to open a car door. Thereby the warning effect is achieved.

The mentioned controller 1 is electrically connected with at least a sensor 2 which is mounted on e.g. an inside handle of car door; besides, the controller 1 is electrically connected with plural sensors 2, wherein the plural sensors 2 are mounted on inside handles of car doors or around respectively. Thereby the warning effect is achieved.

As shown in FIG. 2, the sensor 2 is mounted around an inside handle of car door 102, e.g. on the top, whereby the inside handle of car door 102 is covered by sensing range, whereby the sensor 2 signals the controller and further to start the alert device, before a human hand touches the inside handle of car door. Decoration is also considered, the sensors 2 are installed. Thereby an aesthetical appearance is achieved.

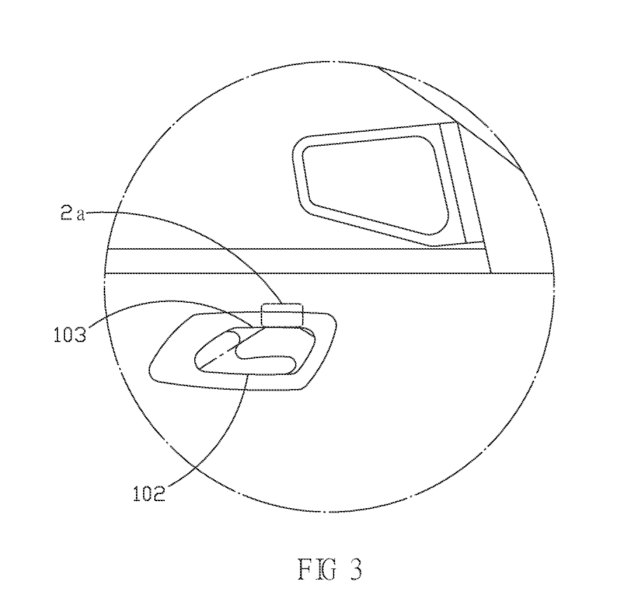

As shown in FIG. 3, todays an inside handle of car door 102 is normally set within a recess 103, therefore, a sensor 2a is embedded within a car door, whereby inside of the recess 103 of handle is covered by the sensing range. Thereby accidental starting is reduced.

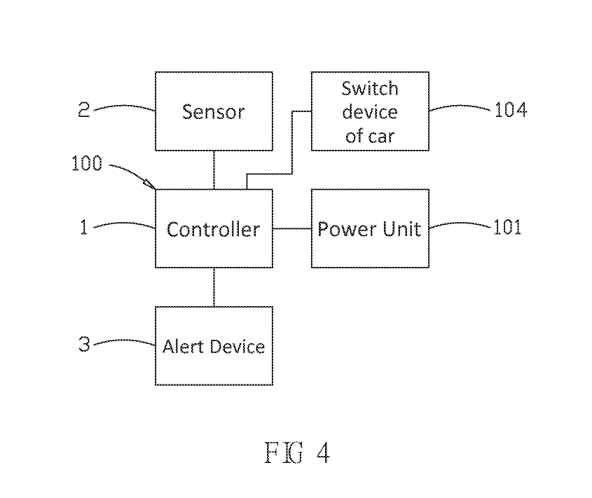

As shown in FIG. 4, not only sensor 2 is used to start the alert device 3, as mentioned, but the controller 1 is also electrically connected with the switch device of car 104, since passengers mostly get off after flameout; wherein the controller 1 signals to start the alert device 3, the car is flameout. Thereby warning effect is achieved.

The said controller 1 has a timing means and/or a continuous touching-on means; wherein the said timing means causes the alert device 3 to work, for a destined time, e.g. for 20 seconds, whereby warning function car driver from rear is improved; wherein the continuous touching-on means causes signals from the sensor 2 to start the alert device 3 and begins to time, e.g. 20 seconds, after the source of starting is out of the sensor 2. In other words, the sensor 2 signals continuously to start the alert device 3, before an object is removed, the sensor 2 is started by the object. Thereby warning function for car driver from rear is improved. The timing means is a conventional skill, which will not be mentioned here.

The alert device 3 electrically connected with the controller 1, consists of one or two or more following devices: the first lighting device 31, the second lighting device 32 and the sound device 33.

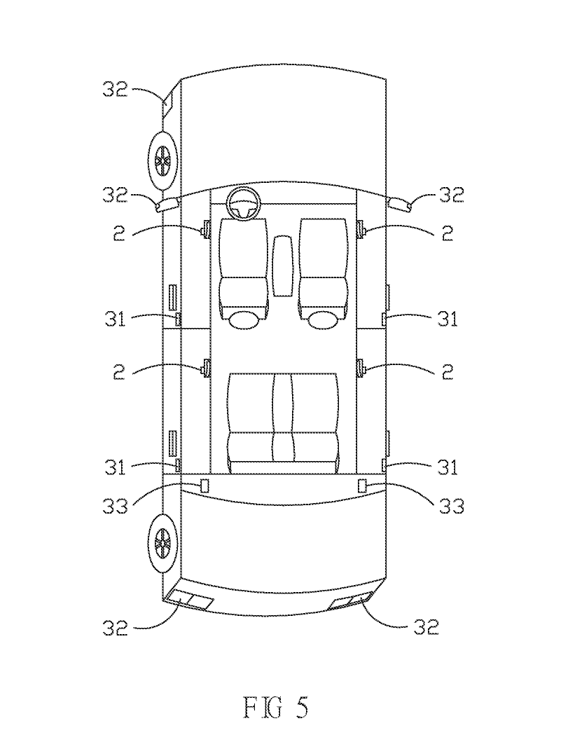

As shown in FIG. 5, the first lighting device 31 is any light or any light of flash, e.g. LED light, which is set on an evident position outside the car, or outside of car doors set with sensors respectively, e.g. around an outside handle of car door, pasted on an outside handle of car door, or combined with it. Thereby the warning effect is achieved.

The mentioned controller 1 has a flash control means; wherein the said flash control means causes the first lighting device 31 of the alert device 3 to flash on. Thereby the warning effect for car driver from rear is improved. The flash means is a conventional skill, which will not be mentioned here.

As shown in FIG. 5, the alert device has plural first lighting devices 31, wherein the plural first lighting devices 31 are set on inside handles of car doors or around respectively, wherein amount of the first lighting devices depends on the amount of car doors. Thereby effect of warning car driver from rear is achieved. Besides, the plural first lighting devices 31 are matched with the sensors 2 mounted on the inside handles of car doors, therefore sensors of the same car only start the corresponding first lighting devices. For example, if the sensor 2 of the right front door is started to work, only the first lighting device of the right front door can be started. Thereby, warning light is actually emitted, once the car door is open.

The second lighting device 32 is automotive lighting of the car or warning light set on the position of automotive lighting of the car with warning effect. The second lighting devices 32 are matched with the respective sensors 2 mounted on the inside handles of car doors, whereby the sensors of the car doors on the same side ca only start the corresponding second lighting devices. For example, once the sensor 2 of the right car door is started, only the automotive lighting for turning right can be started. Thereby warning light is actually emitted.

The sound device 33 giving alarm tone is set on the controller 1 or front and rear of the car inside, whereby driver can identify which door is alarming. Since the sound device 33 is set inside the car, passengers are alerted once a car door is open. Therefore, accidental opening of car door by the passengers is avoided, e.g. children play inside handle of car door, whereby adults prevent the car door to be open, once the sound device 33 sounds alarm.

The first lighting device 31, the second lighting device 32 and the sound device 33 are used individually. Of cause they can also be used combined for improved warning effect.

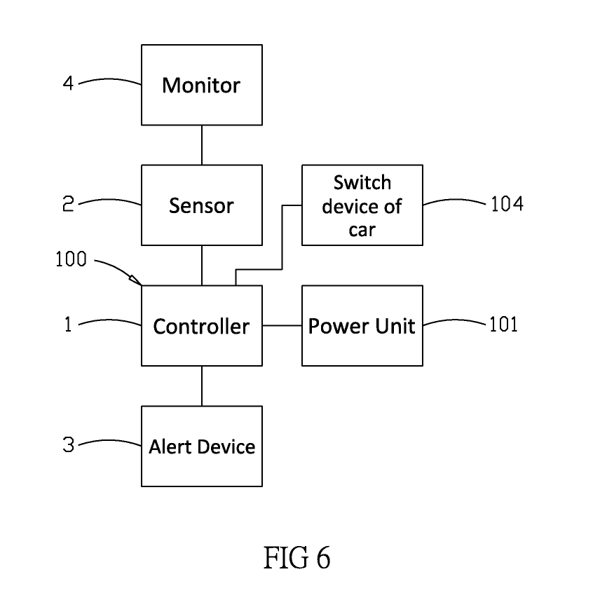

As shown in FIG. 6, the sensor 2 is electrically connected with a monitor 4, which is set on a dashboard of car; wherein an open-closed status of car door is detected by the said sensor 2 which gives signals to the monitor 4, whereby driver can see the open-closed status from the monitor 4.

1. A door opening warning device for car, comprises:
a controller, electrically connected with a power unit;
at least a sensor, electrically connected with the said controller, mounted around an inside handle of car door; and
an alert device, electrically connected with the said controller;
wherein the sensor signals to start the alert device, the sensor is started.

2. The door opening warning device for car of claim 1, wherein the said sensor is an infrared sensor or an electrostatic sensor or any other sensing mode.

3. The door opening warning device for car of claim 2, wherein the said sensor is mounted around an inside handle of car door, whereby the inside handle of car door is covered by the sensing range.

4. The door opening warning device for car of claim 2, wherein the said inside handle of car door is set within a handle recess; wherein the sensor is embedded within a car door, whereby inside of the handle recess is covered by the sensing rang.

5. The door opening warning device for car of claim 1, wherein the controller is electrically connected with a switch device of car; wherein the said controller signals to start the alert device, as car is going to flameout.

6. The door opening warning device for car of claim 1, wherein the controller has a timing means; wherein the timing means causes the alert device to work for a destined time.

7. The door opening warning device for car of claim 1, wherein the controller has a continuous touching-on means; wherein the sensor signals the continuous touching-on means to start the alert device; wherein the continuous touching-on means begins to time, once the source of starting is out of the sensor.

8. The door opening warning device for car of claim 1, wherein the alert device has at least a first lighting device; wherein the first lighting device is LED light or any other light.

9. The door opening warning device for car of claim 8, wherein the controller has a flash control means; wherein the said flash control means causes the first lighting device of the alert device to flash on.

10. The door opening warning device for car of claim 8, wherein the first lighting device is set on an evident position of a car outside.

11. The door opening warning device for car of claim 8, wherein the first lighting devices are se on outside of car doors mounted with sensors respectively.

12. The door opening warning device for car of claim 8, wherein the controller is electrically connected with plural sensors; wherein the plural sensors are mounted on inside handles of car doors or around respectively; wherein the alert device has plural first lighting devices; wherein the plural first lighting devices are set outside of car doors respectively; wherein sensors mounted on car doors of the same car can only start the corresponding first lighting devices.

13. The door opening warning device for car of claim 1, wherein the alert device has at least a second lighting device; wherein the second lighting device is automotive lighting of the car or external warning light set on the position of automotive lighting of the car.

14. The door opening warning device for car of claim 13, wherein the controller is electrically connected with plural sensors; wherein the plural sensors are mounted on inside handles of car doors respectively; wherein the sensors on the same side of car doors start only the corresponding second lighting devices.

15. The door opening warning device for car of claim 1, wherein the alert device has at least a sound device; wherein the sound device is set on the controller or front and rear of the car inside.

16. The door opening warning device for car of claim 1, wherein the sensor is electrically connected with a monitor; wherein the monitor is set on a dashboard of the car; wherein an open-closed status of car door is detected by the sensor, which gives signals to the monitor.

17. The door opening warning device for car of claim 1, wherein the sensor fixed on the rear door has a function as child safety locks, wherein the driver is alerted, as children touch a handle of car door, and prevents it in time, whereby safety of children's sitting in car is improved.
